(19) United States
(12) Patent Application Publication
(10) Pub. No.: US 2005/0179842 A1
(43) Pub. Date: Aug. 18, 2005

(54) Liquid-crystal display

(75) Inventor: Mitsuyoshi Ichihashi, Minami-ashigara-shi (JP)

Correspondence Address: BURNS DOANE SWECKER & MATHIS L L P, POST OFFICE BOX 1404, ALEXANDRIA, VA, 22313-1404, US

(73) Assignee: Fuji Photo Film Co., Ltd., Minami-ashigara-shi (JP)

(21) Appl. No.: 11/058,183

(22) Filed: Feb. 16, 2005

(30) Foreign Application Priority Data
Feb. 16, 2004 (JP) 2004-037836
Mar. 24, 2004 (JP) 2004-086068
Jan. 12, 2005 (JP) 2005-005146

(51) Int. Cl. G02F 1/1335

(52) U.S. Cl. 349/117

(57) ABSTRACT

A novel liquid-crystal display is disclosed. The LCD comprises at least a first polarizing film, a first retardation area, with a positive birefringence, of which an optical axis is perpendicular to a plane, a second retardation area, with a negative birefringence, of which an optical axis is parallel to a plane, and a liquid-crystal cell comprising a pair of substrates and a liquid-crystal layer sandwiched in between the pair of substrates, in which liquid-crystal molecules are parallel to surfaces of the pair of substrates in a black state. A retardation in thickness-direction, Rth, of the first retardation area falls within the range from −40 to −250 nm, an in-plane retardation, Re, of the second retardation area falls within the range from 50 to 400 nm, and a slow axis of the second retardation area is substantially orthogonal to a slow axis of the liquid-crystal layer in a black state.

### CROSS-REFERENCE TO RELATED APPLICATIONS

This application claims benefit of priority under 35 USC 119 to Japanese Patent Application No. 2004-037836, filed Feb. 16, 2004, Japanese Patent Application No. 2004-086068 filed Mar. 24, 2004, and Japanese Patent Application No. 2005-005146 filed Jan. 12, 2005.

### TECHNICAL FIELD

The present invention relates to a liquid crystal display, and especially to an in-plane-switching (IPS) mode display which displays images by being applied the crosswise field to liquid-crystal molecules aligned homogenously.

### RELATED ART

TN-mode liquid-crystal displays have been used widely. The TN-mode DLC usually comprises two polarizing plates and a liquid-crystal layer formed of twisted-orientated nematic liquid crystal sandwiched in between the polarizing plates, and the field is applied in an orthogonal direction to the substrate of the liquid-crystal layer. In the TN-mode, liquid-crystal molecules tilt against the substrate in a black state, and thus, birefringence due to such an orientation of the liquid-crystal molecules generates when being observed in an oblique direction, and light leakage occurs. In order to solve this problem, liquid-crystal cells are optically compensated by a film formed of hybrid-aligned liquid-crystal molecules, and such liquid-crystal displays are put to practical use. However, it is extremely difficult to optically compensate liquid-crystal cells perfectly even if the film formed of hybrid-aligned liquid-crystal molecules are used, and it is not possible to avoid grayscale inversions generating at under areas of images.

Liquid-crystal display employing in-plane switching (IPS) mode, in which the crosswise field are applied to liquid-crystal molecules, or employing vertically aligned (VA) mode, having multi domains divided by projections formed in a panel or slit electrodes, are provided, and are put to practical use. Recently, such liquid-crystal displays have been developed as a panel employed not only in monitors but also in TV, and the brightness thereof has been improved remarkably. Consequently, small light leakage generating at opposing corners in the black state while being observed in an oblique direction has come to the surface as a cause of lowering displaying quality.

In order to improve color tones or viewing angles in the black state, it has been also tried that an optical compensatory material having a birefringence property is disposed between a liquid-crystal layer and a polarizing plate in an IPS mode display. Improved IPS mode displays are disclosed in JPA No. hei 9-80424 (the term “JPA” as used herein means an “unexamined published Japanese patent application (Kohkai Tokkyo Kohou)”), JPA hei 10-54982, JPA No. hei 11-202323, JPA No. hei 9-292522, JPA No. hei 11-133408, JPA No. hei 11-305217 and JPA No. hei 10-307291.

Many of the proposed methods are methods to improve viewing angles by counteracting the birefringence of liquid crystal in the cell, and cannot sufficiently prevent light leakage generating while the liquid-crystal displays are observed in oblique direction, or, in other words, the polarizing axes are out of orthogonal alignment. Some of the proposed methods are for lowering such light leakage and, however, even if such methods are employed, it is extremely difficult to optically compensate the liquid-crystal cell perfectly. Known optical compensatory sheets used for an IPS mode liquid-crystal cell are thick since they consists of plural films, and this is disadvantageous for thinning of liquid-crystal displays. Some of the optical compensatory sheets are prepared by stacking stretched films with adhesion layers. The adhesion layers shrink depending on variation of temperature or humidity, and, thus, some of the stretched films peel or film warpage is sometimes occurred.

### SUMMARY OF THE INVENTION

One object of the present invention is to provide an IPS mode liquid-crystal display, having a simple configuration, improved in not only displaying-qualities but also viewing angles.

From one aspect the present invention provides a liquid-crystal display comprising at least;
a first polarizing film,
a first retardation area, with a positive birefringence, of which an optical axis is perpendicular to a plane;
a second retardation area, with a negative birefringence, of which an optical axis is parallel to a plane; and
a liquid-crystal cell comprising a pair of substrates and a liquid-crystal layer sandwiched in between the pair of substrates, in which liquid-crystal molecules are parallel to surfaces of the pair of substrates in a black state;
wherein a retardation in thickness-direction, Rth, of the first retardation area falls within the range from −40 to −250 nm, an in-plane retardation, Re, of the second retardation area falls within the range from 50 to 400 nm, and a slow axis of the second retardation area is substantially orthogonal to a slow axis of the liquid-crystal layer in a black state.

In one embodiment of the present invention, the first polarizing film, the first retardation area, the second retardation area and the liquid-crystal cell are disposed in this order, and the slow axis of the second retardation area is substantially parallel to a transmission axis of the first polarizing film; and in another embodiment, the first retardation area, the liquid-crystal cell, the second retardation area and the first polarizing film are disposed in this order, and the slow axis of the second retardation area is substantially orthogonal to a transmission axis of the first polarizing film.

The liquid-crystal display of the present invention may further comprise a second polarizing film of which a transmission axis is orthogonal to the transmission axis of the first polarizing film and the first retardation area, the second retardation area and the liquid-crystal cell may be disposed between the first and the second polarizing films.

The first retardation area may comprise a retardation layer comprising rod-like liquid crystal molecules aligned vertically, or may comprise a retardation layer comprising discotic liquid-crystal molecules aligned vertically.

The liquid-crystal display of the present invention may further comprise a pair of protective films sandwiching the first polarizing film. The retardation in thickness direction, Rth, of the protective film, being disposed nearer to the liquid-crystal cell than another, is preferably not greater than 25 nm. Such a protective film may be formed of a cellulose acrylate film or a norbornene film.

According to the present invention, it is possible to improve the contrast when LCD is observed in an oblique direction, especially in a 45° oblique direction, and the angle between two transmission axes of two polarizing plates is out of 90°, without lowering displaying qualities in the frontal direction, by employing a first retardation area, with a positive birefringence, of which an optical axis is perpendicular to a plane and of which thickness direction retardation, Rth, is from −40 nm to −250 nm; and a second retardation area, with a negative birefringence, of which an optical axis is parallel to a plane, and of which in-plane retardation, Re, is from 50 nm to 400 nm; and by disposing the second retardation area so that the slow axis of the second retardation area is substantially orthogonal to a slow axis of the liquid-crystal layer in a black state.

And the embodiment, in which the Rth value of a protective film of the polarizing film is not greater than 20 nm, can give more improved contrast

### BRIEF DESCRIPTION OF THE DRAWING

FIG. 1 is a viewing showing a frame format of an example of a pixel area of the liquid-crystal display of the present invention.

FIG. 2 is a viewing showing a frame format of one embodiment of the liquid-crystal display of the present invention.

FIG. 3 is a viewing showing a frame format of another embodiment of the liquid-crystal display of the present invention.

In figures, the numerical numbers mean as follows:

1 a pixel area,

2 a pixel electrode,

3 a displaying electrode,

4 a rubbing direction,

5a and 5b directors of liquid-crystal molecules in a black state,

6a and 6b directors of liquid-crystal molecules in a white state,

7a, 7b, 19a and 19b protective films for a first and a second polarizing films,

8, 20 a first and second polarizing films,

9, 21 a transmission axes of a first and second polarizing films,

10 a second retardation area film,

11 a slow axis of a second retardation area

12, 16 substrates for a liquid-crystal cell,

13, 17 rubbing directions of a substrate,

14 a liquid-crystal layer,

15 a slow axis of liquid-crystal layer, and

18 a first retardation area

### DETAILED DESCRIPTION OF THE INVENTION

Hereafter, the present invention will be explained in detail. In the specification, ranges indicated with “to” mean ranges including the numerical values before and after “to” as the minimum and maximum values.

In the specification, Re and Rth respectively mean an in-plane retardation and retardation in a thickness-direction at wavelength 550 nm. The Re is measured by using KOBRA-21ADH (manufactured by Oji Scientific Instruments) for an incoming light of a wavelength 550 nm in a direction normal to a film-surface. The Rth is calculated by using KOBRA-21ADH based on three retardation values; first one of which is the Re obtained above, second one of which is retardation which is measured for an incoming light of a wavelength 550 nm in a direction rotated by +40° with respect to the normal direction of the film around an in-plane slow axis, which is decided by KOBRA 21ADH, as an inclining axis (a rotation axis), and third one of which is a retardation which is measured for an incoming light of a wavelength 550 nm in a direction rotated by −40° with respect to the normal direction of the film around an in-plane slow axis as an inclining axis (a rotation axis); a hypothetical mean refractive index and an entered thickness value of the film. The mean refractive indexes of various materials are described in published documents such as “POLYMER HANDBOOK” (JOHN WILEY&SONS, INC) and catalogs. If the values are unknown, the values may be measured with Abbe refractometer or the like. The mean refractive indexes of major optical films are exemplified below:
cellulose acylate (1.48), cyclo-olefin polymer (1.52), polycarbonate (1.59), polymethyl methacrylate (1.49), polystyrene (1.59).

When the hypothetical mean refractive index and a thickness value are put into KOBRA 21ADH, nx, ny and nz are calculated. Being measured for an incoming light of a wavelength 550 nm in a direction rotated by +20° with respect to the normal direction of the film around an in-plane slow axis (as a rotation axis), when the obtained value is greater than the Re value, the Rth is decided to be positive; and, on the other hand, when the obtained value is lower than the Re value, the Rth is decided to be negative. For a sample film having the |Rth/Re| value of not smaller than 9, being observed using a polarization microscope equipped with a rotatable base with an incoming light of a wavelength 550 nm in a direction rotated by +40° with respect to the normal direction of the film around an in-plane slow axis (as a rotation axis), when the slow axis to be decided by an inspection polarizing plate is parallel to the surface of the sample film, the Rth is decided to be positive; and, on the other hand, when the slow axis is in a thickness direction, the Rth is decided to be negative.

In the specification, the term of “A is parallel to B” or the term of “A is orthogonal to B” means that the angle between A and B falls within a range of an exact angle ±10°. The angle desirably falls within a range of an exact angle ±5°, and more desirably within a range of an exact angle ±2°. The term of “substantial verticality” means that an angle falls within a range of an exact angle ±20°. The angle desirably falls within a range of an exact angle ±15°, and more desirably within a range of an exact angle ±10°. The term of “slow axis” means a direction giving a maximum refractive index. As long as written specifically, refractive indexes are measured at 550 nm.

In the specification, the terms of “polarizing plate” means not only polarizing plates having a proper size to be employed in a liquid-crystal but also long polarizing plates before being cut. And in the specification, the terms of “polarizing film” is distinct from the term “polarizing plate”, and the term of “polarizing plate” is used for any laminated body comprising a “polarizing film” and at least one protective film thereon.

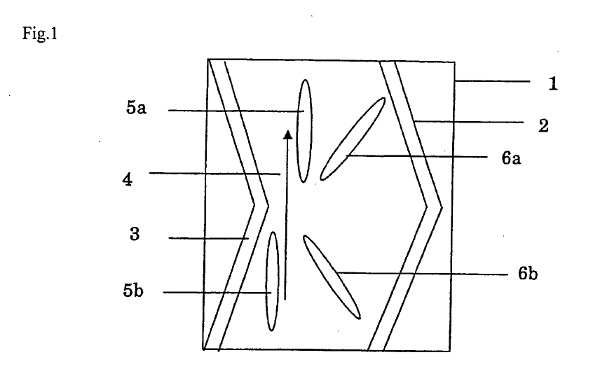

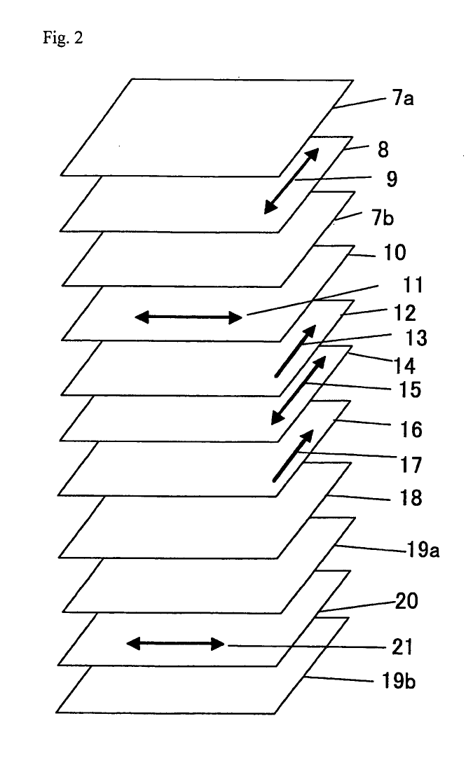

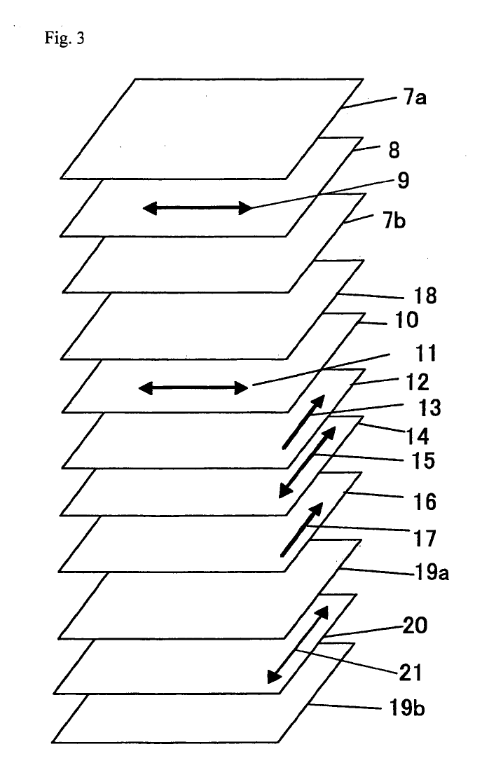

Embodiments of the present invention will be described in detail with reference to drawings. FIG. 1 is a viewing showing a frame format of an example of a pixel area of the liquid-crystal display of the present invention. FIGS. 2 and 3 are viewings showing a frame format of embodiments of the present invention.

[Liquid-Crystal Display]

The liquid-crystal display shown in FIG. 2 comprises polarizing films 8 and 20, a second retardation area 10, substrates 12 and 16, a liquid-crystal layer 14 sandwiched in between the substrates 12 and 16, and a first retardation area 18. The first polarizing film 8 and the second polarizing film 20 are sandwiched in between a protective film 7a and 7b and 19a and 19b respectively.

The liquid-crystal display shown in FIG. 2, a liquid-crystal cell comprises the substrates 12 and 16 and the liquid-crystal layer 14 sandwiched in between them. For an IPS-mode liquid-crystal cell without twisting structures in a transmission mode, the best value of product (Δn·d) of a thickness of a liquid-crystal layer, d (μm), and a refractive-index anisotropy, Δn, is 0.2 to 0.4 μm. When the product is set in the range, the liquid-crystal display, giving a high brightness in a white state and a low brightness in a black state, or, in other words, giving a high contrast and high brightness, can be obtained. Alignment layers (not shown) are formed on the surfaces, contacting the liquid-crystal layer 14, of the substrates 12 and 16, and thus, the liquid-crystal molecules are aligned parallel to the surfaces of the substrates and their orientations are controlled along with rubbing directions 13 and 17 of the alignment layers, in the field-free state or in the low-field applied state. And electrodes (not shown in FIG. 2), which can apply the field to liquid-crystal molecules, are formed on the inner surfaces of the substrates 12 or 16.

A viewing showing the orientation of liquid-crystal molecules in a pixel area of the liquid-crystal layer 14 is shown in FIG. 1. FIG. 1 is a viewing showing the orientation of liquid-crystal molecules in an extremely small area corresponding to a pixel area with the rubbing direction 4 applied to the surfaces of the substrates 12 and 16 and electrodes 2 and 3, formed on the inner surfaces of the substrates 12 and 16 to apply the field to liquid-crystal molecules. When nematic liquid crystal, having a positive dielectric-constant anisotropy, is used as a field-effect type liquid crystal and active driving is carried out, the orientations of the liquid-crystal molecules are 5a and 5b in the field-free state or the low-field-applied state, and, then, this state displays black. When the field is applied between the electrodes 2 and 3, the liquid-crystal molecules change the orientations from the directions 5a and 5b to the directions 6a and 6b. Usually, this state displays white.

To return to FIG. 2, the transmission axis 9 of the polarizing film 8 is orthogonal to the transmission axis 21 of the polarizing film 20. The slow axis 11 of the second retardation area 10 is orthogonal to the transmission axis 9 of the polarizing film 8 and to the slow axis 15 of the liquid-crystal molecules in the liquid-crystal layer 14 in a black state.

In the liquid-crystal display shown in FIG. 2, the polarizing film 8 is sandwiched in between protective films 7a and 7b, and however, the protective film 7b may be absent. The polarizing film 20 is also sandwiched in between the protective film 19a and 19b, and however, the protective film 19a, which is disposed nearer to the liquid-crystal layer 14 than 19b, may be absent.

Another embodiment of the present invention is shown in FIG. 3. The liquid-crystal display shown in FIG. 3 has a same configuration as that shown in FIG. 2, except that a first retardation area 18 is disposed between a polarizing film 18 and a second retardation area 10. For the embodiment shown in FIG. 3, a protective film 7b or a protective film 19 a may be absent. A transparent substrate may be disposed between the first retardation area 18 and the protective film 7b, or between the first retardation area 18 and the second retardation area 10.

According to the liquid-crystal display shown in FIG. 3, the second retardation area 10 is disposed such that the slow axis 11 is parallel to the transmission axis 9 of the polarizing film 8 and is orthogonal to the slow axis 15 of the liquid-crystal molecules in the liquid-crystal layer 14 in a black state.

It is noted that, for the embodiment shown in FIG. 3, the first and second retardation areas may be disposed between the liquid-crystal cell and the observed-side polarizing film or between the liquid-crystal cell and the backside polarizing film. For both embodiments, the second retardation area is disposed nearer to the liquid-crystal cell than the first retardation area.

In FIG. 2 or 3, one embodiment employing a transmissive liquid-crystal display comprising upper-side and under-side polarizing plates, is shown, and, however, the present invention includes any embodiments employing a reflective liquid-crystal display comprising a single polarizing plate. In such embodiments, the best value of Δn·d is about ½ of that described above since the light path is twice as length of that in the embodiment described above.

The mode of the liquid-crystal cell which can be employed in the present invention is not limited to an IPS-mode, and any modes, in which liquid-crystal molecules are substantially parallel to the surfaces of the pair of substrates in a black state, can be employed in the present invention. Examples of liquid-crystal display employing such a mode include ferroelectric liquid-crystal displays, anti-ferroelectric liquid-crystal displays and ECB liquid-crystal displays.

The configuration of the liquid-crystal display of the present invention is not limited to the embodiment shown in FIGS. 1 to 3, and may further comprise other members. A color filter may be disposed between the liquid-crystal layer and the polarizing film. And an antireflection treatment or a hard coat treatment may be applied to the surface of the protective film of the polarizing film. Conductive members may be used. For the transmissive mode, a back light having a light source such as a cold cathode, a hot cathode fluorescent tube, light-emitting diode, field-emission element or electroluminescent element may be disposed at a back face. A backlight may be disposed at the upper side or the lower side shown in FIG. 2 or 3. A reflective polarizing plate, a prism sheet or an optical waveguide may be also disposed between the liquid-crystal layer and the back-light. The liquid-crystal display of the present invention may be reflective-mode LCD, and in such an embodiment, a single polarizing plate may be disposed at viewing side and a reflective film may be disposed a back face or an inner face of the under-side liquid-crystal cell. It is possible to dispose a front light having the light source described above at a viewing side of the liquid-crystal cell.

Embodiments of the present invention include direct types projection types and light modulation types. The embodiments of active-matrix liquid-crystal displays comprising a 3 or 2 terminal semiconductor device such as a TFT or a MIM are especially effective. The embodiments of passive matrix, or, in other words, time-division driving, liquid-crystal displays are effective as well as the above embodiments.

Next, various members which can be employed in the liquid-crystal displays of the present invention will be described in details with respect to their preferred optical properties, their materials, processes for producing them or the like.

[First Retardation Area]

The liquid-crystal display of the present invention comprises a first retardation area with positive birefringence. The optical axis of the first retardation area is substantially perpendicular to the layer surface. The retardation in thickness direction, Rth, is set within the range from −40 nm to −250 nm. The preferred rang of the Rth may be varied depending on optical properties of other members, especially the protective film (such as a triacetyl cellulose film) of the polarizing film disposed nearer to the first retardation area. In order to lower light leakage in an oblique direction, it is preferred that the Rth of the first retardation area is set within the range from −60 nm to −200 nm; and it is more preferred that he Rth of the first retardation area is set within the range from −70 nm to −180 nm. On the other hand, the in-plan retardation, Re, of the first retardation area is not limited to a certain range, and, usually, it is preferred that the Re of the first retardation area is from 0 to 50 nm; and it is more preferred that the Re of the first retardation area is from 0 to 20 nm.

As long as a first retardation area exhibiting the proper optical properties can be produced, any materials may be used for producing the first retardation area and any configurations may be employed in the first retardation area. For example, birefringent polymer films may be used as a first retardation area. Retardation layers, formed by applying or transferring a composition comprising at least one high-molecular or low-molecular weight liquid-crystal compound to a transparent substrate, may be also used as a first retardation area. The first retardation area may comprise plural layers, and in such an embodiment, two or more birefringent films, two or more retardation layers or at least one birefringent layer and at least one retardation layer may be stacked.

<<First Retardation Area Comprising a Birefringent Polymer Film>>

The birefringent film, which can be employed in the first retardation area, may be easily produced by stretching a polymer film in thickness direction. Some cellulose acylates with an additive for controlling Rth can generate such optical properties by solvent-casting method without any stretching step. And films formed such cellulose acylates are preferably used in the first retardation area Examples of such cellulose acylate are described in the specification of Japanese Application No. 2003-337683.

<<First Retardation Area Comprising a Retardation Layer Formed of a Liquid Crystal Composition>>

One example of the retardation layer formed of a liquid-crystal composition, which can be employed in the first retardation area, is a layer formed by applying and drying vinyl carbaozole series polymers described in JPA No. 2001-091746. Another example is a layer formed by aligning cholesteric liquid-crystal molecules such that the helical axis is vertical to the substrate surface and fixing the molecules in the alignment state, or a layer formed by aligning rod-like liquid-crystal molecules with positive birefringence vertically and fixing the molecules in the alignments state, which are described in JPA No. hei 6-331826 or Japanese Patent No. 2853064. The first retardation area may consist of a single layer or plural layers to exhibit the proper optical properties. The first retardation area may be produced by laminating a retardation layer formed of a liquid-crystal composition on a substrate supporting the layer such that the laminated body as a whole can satisfy the required optical properties for the first retardation area. Among the rod-like liquid-crystal compounds, compounds, exhibiting a nematic liquid-crystal phase, a smectic liquid-crystal phase or a lyotropic liquid-crystal phase at a temperature to be set for fixing the molecules, are preferably used. When a rod-like liquid-crystal compound, exhibiting the above phase at the temperature in the presence of an additive, is used, a composition comprising the rod-like compound and the additive may be used for producing the retardation layer.

<<Rod-Like Liquid-Crystal Compound>>

The first retardation area may be formed of a composition comprising at least one rod-like liquid-crystal compound. Examples of the rod-like compound include azomethines, azoxys, cyanobiphenyls, cyanophenyl esters, benzoic acid esters, cyclohexanecarboxylic acid phenyl esters, cyanophenylcyclohexanes, cyano-substituted phenylpyrimidines, alkoxy-substituted phenylpyrimidines, phenyl dioxanes, tolans and alkenylcyclohexyl benzonitriles. Examples of the rod-like liquid crystal compounds further include liquid-crystal polymers. Liquid-crystal molecules having partial structures capable of polymerizing or crosslinking when being applied active ray, electron ray or heat are preferably used. The number of the partial structure included in the molecule is desirably from 1 to 6 and more desirably from 1 to 3.

For the embodiment in which the first retardation area comprises a retardation layer formed of a composition comprising a rod-like liquid-crystal compound, a retardation layer in which rod-like molecules are substantially aligned vertically is desirably used. In the specification, the term of “substantially aligned vertically” for rod-like compounds means that a mean angle (a mean tilt angle) between a director of a rod-like liquid-crystal compound and a surface of the layer is from 70 to 90°. These rod-like liquid-crystal molecules may be aligned obliquely or aligned such that a tilt angle of the molecules varies along with a distance from the substrate or, in other words, hybrid-aligned. For any oblique-alignment or ay hybrid-alignment, the mean tilt angle is desirably from 70 to 90°, more desirably from 75 to 90°, much more desirably from 80 to 90° and further much more desirably from 85 to 95°.

Other materials, other than liquid-crystal compound, such as coating-liquid solvents, polymerizable monomers or polymerization initiators may be used for producing the retardation layer, and examples of them are same as those exemplified later for a retardation layer of the second retardation area.

[Second Retardation Area]

The liquid-crystal display of the present invention comprises a second retardation area with negative birefringence. The optical axis of the second retardation area is substantially parallel to the layer surface, or in other words is in-plane. The in-plane retardation, Re, of the second retardation area is from 50 to 400 nm. The second retardation area is disposed such that the slow axis of the second retardation area is orthogonal to the slow axis of the liquid-crystal cell in a black state. From the viewpoint of lowering light leakage in an oblique direction effectively, the Re of the second retardation area is preferably from 90 nm to 300 nm, and more preferably from 120 nm to 250 nm.

As long as a second retardation area exhibiting the proper optical properties can be produced, any materials may be used for producing the second retardation area and any configurations may be employed in the second retardation area For example, birefringent polymer films may be used as a second retardation area Retardation layers, formed by applying or transferring a composition comprising at least one high-molecular or low-molecular weight liquid-crystal compound to a transparent substrate, may be also used as a second retardation area. The second retardation area may comprise plural layers, and in such an embodiment, two or more birefringent films, two or more retardation layers or at least one birefringent film and at least one retardation layer may be stacked.

<<Second Retardation Area Comprising a Birefringent Polymer Film>>

The birefringent film, which can be employed in the second retardation area, may be easily produced by stretching a polymer film. The polymers with negative inherent birefringence are preferred as material of the birefringence film. Examples of the polymer with negative inherent birefringence include polystyrenes such as homopolymers of styrene or styrene derivatives, copolymers of styrene or styrene derivatives and other monomers, graft copolymers of styrene or styrene derivatives and other monomers and mixtures thereof.

Examples of the homopolymers of styrene or styrene derivatives include homopolymers of styrene, α-methyl styrene, o-methylstyrene, p-methylstyrene, p-chlorostyrene, o-nitrostyrene, p-aminostyrene, p-carboxylstyrene, p-phenylstyrene, or 2,5-dichloro styrene. Examples of the copolymer of styrene or styrene derivatives and other monomers include styrene/acrylonitrile copolymer, styrene/methacrylonitrile copolymer, styrene/methyl methacrylate copolymer, styrene/ethyl methacrylate copolymer, styrene/α-chloro acrylonitrile copolymer, styrene/methyl acrylate copolymer, styrene/ethyl methacrylate copolymer, styrene/butyl acrylate copolymer, styrene/acrylic acid copolymer, styrene/methacrylic acid copolymer, styrene/butadiene copolymer, styrene/isoprene copolymer, styrene/maleic anhydride copolymer, styrene/itaconic acid copolymer, styrene/vinyl carbazole copolymer, styrene/N-phenyl acrylamide copolymer, styrene/vinyl pyridine copolymer, styrene/vinyl naphthalene copolymer, α-methylstyrene/acrylonitrile copolymer, α-methylstyrene/methacrylonitrile copolymer, α-methylstyrene/vinyl acetate copolymer, styrene/α-methylstyrene/acrylonitrile copolymer, styrene/α-methylstyrene/methyl methacrylate copolymer and styrene/styrene derivative copolymer. Among styrene polymers, graft copolymers obtained by graft-polymerization of styrene/butadiene copolymers with at least one selected from the group consisting of styrene, acrylonitrile and α-methylstyrene are preferred. The styrene polymers are described in JPA No. hei 4-97322 and JPA No. hei 6-67169. It is possible to produce a mono-axially oriented polymer film, an optical axis of which is parallel to the substrate, by mono-axially stretching a polymer with negative inherent birefringence such as the above styrene polymers.

<<Second Retardation Area Comprising a Retardation Layer Formed of a Liquid Crystal Composition>>

The retardation layer formed of a liquid-crystal composition, which can be employed in the second retardation area, may be produced by applying a composition comprising a discotic liquid-crystal compound with negative birefringence to a surface of a substrate or temporary substrate, aligning the discotic molecules vertically such that the optical axis is substantially parallel to the substrate surface, and fixing the molecules in the alignment state. When the layer is formed on the temporary substrate, the layer may be transferred from on the temporary substrate to on a substrate. The second retardation area may consist of a single layer or plural layers to exhibit the proper optical properties. The second retardation area may be produced by laminating a retardation layer formed of a liquid-crystal composition on a substrate supporting the layer such that the laminated body as a whole can satisfy the required optical properties for the second retardation area.

<<Discotic Liquid-Crystal Compound>>

Discotic liquid-crystal compounds described in various literatures such as Mol. Crysr. Liq. Cryst., vol. 71, page 111 (1981), C. Destrade et al.; Quarterly Chemistry Survey, No. 22, The Chemistry of Liquid Crystals, Chapter 5, Chapter 10, Section 2 (1994), ed. by Japan Chem. Soc.; Angew. Chem. Soc. Chem. Comm., page 1794 (1985), B. Kohne et al.; J. Am. Chem. Soc., vol. 116, page 2,655 (1994), J. Zhang et al. may be used in the present invention. The polymerization of discotic liquid-crystal molecules is described in JPA No. hei 8-27284.

It is necessary to bond a polymerizable group as a substituent to the disk-shaped core of a discotic liquid-crystal molecule to better fix the discotic liquid-crystal molecules by polymerization. However, when a polymerizable group is directly bonded to the disk-shaped core, it tends to be difficult to maintain alignment during the polymerization reaction. Accordingly, the discotic liquid-crystal molecule desirably comprises a linking group between the disk-shaped core and the polymerizable group. That is, the discotic liquid-crystal molecule is desirably the compound denoted by a formula below.
D(-L-P)ₙ

In the formula, D represents a discotic core, L represents a divalent linking group, p represents a polymerizable group and n is an integer from 4 to 12. Specific examples of the discotic core (D), the linking group (L) and the polymerizable group (P) are (D1) to (D15), (L1) to (L25) and (P1) to (P18), described in JPA No. 20014837, respectively, and the descriptions about those in JPA No. 2001-4837 are used in the present invention.

According to the embodiment in which the second retardation area comprises a retardation layer comprising discotic molecules substantially aligned vertically, the second retardation area is disposed such that the slow axis of the retardation layer is orthogonal to the slow axis of the liquid-crystal cell in a black state. The Re of the second retardation area may be adjusted to a preferred range by controlling a thickness of the layer produced by coating. According to the present invention, it is required that discotic liquid-crystal molecules are substantially aligned vertically to the substrate surface, or in other words aligned with a mean tilt angle of 70 to 90°. In the specification, the term of “substantially aligned vertically” means that a mean angle (a mean tilt angle) between a disc-face and the layer surface is from 70 to 90°. These discotic liquid-crystal molecules may be aligned obliquely or aligned such that a tilt angle of the molecules varies along with a distance from the substrate or, in other words, hybrid-aligned. For any oblique-alignment or ay hybrid-alignment, the mean tilt angle is desirably from 70 to 90°, more desirably from 75 to 90° and much more desirably from 80 to 90°. When the mean tilt angle is lower than the range, light leakage may diffuse asymmetrically.

<<Preparation of a Second Retardation Area Comprising a Retardation Layer>>

The retardation layer, which can be employed in the second retardation area, may be prepared by applying a coating liquid comprising a discotic liquid-crystal compound and, if necessary, polymerization initiator, an additive for vertical alignment at an air-interface or the like, to a surface of a vertical alignment layer, aligning the discotic molecules vertically, and fixing the discotic molecules in the alignment state. Solvents are used for preparing the coating liquid, and the solvent is desirably selected from organic solvents. Examples of the organic solvent include amides such as N,N-dimethylformamide, sulfoxides such as dimethyl sulfoxide, heterocyclic compounds such as pyridine, hydrocarbons such as benzene and hexane, alkyl halides such as chloroform and dichloromethane, esters such as methyl acetate and butyl acetate, ketones such as acetone and methyl ethyl ketone and ethers such as tetrahydrofuran and 1,2-dimethoxyethane. Alkyl halides and ketones are preferred. One or more kinds of solvents may be used for preparing the coating solutions.

The coating liquid can be applied by known techniques (e.g., extrusion coating, direct gravure coating, reverse gravure coating and die coating).

The liquid-crystal molecules may be fixed in the alignment state. The discotic liquid-crystal molecules are desirably fixed by polymerization reaction of the polymerizable group (P). Polymerization reactions include thermal polymerization reactions employing a thermal polymerization initiator and photo-polymerization reactions employing a photo-polymerization initiator. A photo-polymerization reaction is preferred. Examples of photo-polymerization initiators are alpha-cabonyl compounds (described in U.S. Pat. Nos. 2,367,661 and 2,367,670), acyloin ether (described in U.S. Pat. No. 2,448,828), alpha-hydrocarbon-substituted aromatic acyloin compounds (described in U.S. Pat. No. 2,722,512), polynuclearquinone compounds (described in U.S. Pat. Nos. 3,046,127 and 2,951,758), combinations of triarylimidazole dimers and p-aminophenyl ketones (described in U.S. Pat. No. 3,549,367), acridine and phenadine compounds (described in JPA No. sho 60-105667 and U.S. Pat. No. 4,239,850), and oxadiazole compounds (described in U.S. Pat. No. 4,212,970).

The amount of photo-polymerization initiator employed is desirably from 0.01 to 20 weight percent, preferably from 0.5 to 5 weight percent, of the solid portion of the coating liquid Irradiation for polymerization of discotic liquid-crystal molecules is desirably conducted with ultraviolet radiation. The irradiation energy is desirably from 20 mJ/cm² to 50 J/cm², preferably from 100 to 800 mJ/cm². Irradiation may be conducted under heated conditions to promote the photo-polymerization reaction.

The first or second retardation area comprising the retardation layer formed of a liquid-crystal compound desirably has a thickness from 0.1 to 10 μm, more desirably from 0.5 to 5 μm and much more desirably from 1 to 5 μm.

(A Vertical-Alignment Layer)

In order to align liquid-crystal molecules vertically at an alignment layer, an alignment layer having a low surface energy should be used. In particular, the functional groups of the polymer in the alignment layer reduce the surface energy of the alignment layer, to align liquid-crystal molecules vertically. Fluorine atom or hydrocarbon groups having 10 or more carbon atoms are effective as the functional group capable of reducing the surface energy of the alignment layer. A fluorine atom or a hydrocarbon group is preferably introduced into side chain rather than into main chain, for existing them at the surface of the alignment layer. The amount of fluorine atoms included in a fluoride-polymer is desirably from 0.05 to 80 wt %, more desirably from 0.1 to 70 wt %, much more desirably from 0.5 to 65 wt % and further much more desirably from 1 to 60 wt %. The hydrocarbon group is selected from aliphatic groups, aromatic group and any combinations thereof. The aliphatic group may have a cyclic, branched chain or linear chain structure. The aliphatic group is desirably selected from alkyl groups (including cycloalkyl groups) or alkenyl groups (including cycloalkenyl groups). The hydrocarbon group may have a low-hydrophilic substituent such as a halogen atom. The carbon atom number of the hydrocarbon group is desirably from 10 to 100, more desirably from 10 to 60, and much more desirably from 10 to 40. The main chain of the polymer desirably has a polyimide or polyvinyl alcohol structure.

Generally, polyimides are produced by condensation reaction of tetra-carboxylic acids and diamines. Copolymer-like polyimides which are produced by condensation reactions of plural tetracaboxylic acids and plural diamines may be used. Fluorine atoms or hydrocarbon groups may exist in repeating units derived from tetra-arboxylic acids and/or in repeating units derived from diamines. When hydrocarbon groups are introduced into polyimide, it is preferred that steroid structure is formed in main chain or side chain of the polyimide. The steroid structure existing in side chain corresponds to the hydrocarbon group having 10 or more carbon atoms and contributes to aligning liquid-crystal molecules vertically. In the specification, the term of “steroid structure” is used any cyclopentanone phenanthrene ring structures or any ring structures which can be obtained by replacement of a part of single bonds thereof with double bonds within a replacement range such that the rings are cycloaliphatic or, in other words, the rings don't form aromatic rings.

The liquid-crystal compounds may be aligned vertically by mixing an organic acid with polymers such as polyvinyl alcohol, modified polyvinyl alcohol or polyimide. Examples of the organic acid to be mixed include carboxylic acids, sulfonic acids and amino acids. Among vertical-alignment agents, described below, the agent exhibiting acidity may be used. The amount of the organic acid is desirably from 0.1 to 20 wt %, and more desirably from 0.5 to 10 wt % with respect to the weight of polymer.

The saponification degree of the polyvinyl alcohol is desirably from 70 to 100%, and more desirably from 80 to 100%. The polymerization degree of the polyvinyl alcohol is desirably from 100 to 5000.

For aligning discotic liquid-crystal molecules, an alignment layer formed of a polymer of which side chains have a hydrophobic group as a function group is desirably used. The types of the function group may be decided depending on various factors such as types of the liquid-crystal compounds or desired alignment state. For example, the modification group can be introduced into the polyvinyl alcohol by copolymerization modification, chain-transfer modification or bloc-polymerization modification. Examples of the modified group include hydrophilic groups such as a carboxylic acid group, a sulfonic acid group, a phosphoric acid group, an amino group, an ammonium group, an amide group or a thiol group; C₁₀₋₁₀₀ hydrocarbon groups; hydrocarbon groups substituted with fluorine atoms; thioether groups, polymerizable groups such as an unsaturated polymerizable group, an epoxy group or an aziridile group; and alkoxysilyl groups such as tri-, di- or mono-alkoxysilyl group. Specific examples of such modified polyvinyl alcohols include those described in the columns [0022] to [0145] in JPA No. 2000-155216 and those described in the columns [0018] to [0022] in JPA No. 2002-62426.

When a polymer having a main chain bonding to side chains containing a crosslinkable functional group, or a polymer having side chain being capable of aligning liquid-crystal molecules and containing a crosslinkable functional group is used for forming an alignment layer, and a composition comprising a multi-functional monomer is used for preparing a retardation layer, it is possible to copolymerize the polymer in the alignment layer and the multi-functional monomer in the retardation layer formed on the alignment layer. In such case, not only between the multi-functional monomers but also between the polymers in the alignment layer and between the multi-functional monomers and the polymers in the alignment layer, the covalent bondings are formed and the bonding strengths between the alignment layer and the retardation layer are improved.

The polymer in the alignment layer desirably has crosslinkable functional group containing a polymerizable group. Specific examples include those described in the columns of [0080] to [0100] in JPA No. 2000-155216.

The polymer in the alignment layer may be crosslinked by a crosslinkable agent Examples of the crosslinkable agent include aldehydes, N-methylol compounds, dioxane derivatives, compounds to act when being activated their carboxyl groups, active vinyl compounds, active halogen compounds, isoxazoles and dialdehyde starches. A single or plural type of crosslinkable agents may be used. Specific examples of the crosslinkable agent include the compounds described in the columns [0023] to [0024] in JPA No. 2002-62426. Aldehydes having a high reaction-activity are preferred, and glutaraldehydes are more preferred.

The amount of the crosslinkable agent is desirably set from 0.1 to 20 wt %, and more desirably 0.5 to 15 wt %, with respect to the weight of the polymer. The residual amount of the unreacted crosslinkable-agent in the alignment layer is desirably not greater than 1.0 wt %, and more desirably not greater than 0.5 wt %. When the residual amount falls within the range, the alignment layer has a sufficient durability, and even if the alignment layer is used in a liquid-crystal display for a long time, or is left under a high temperature and humidity atmosphere for a long time, no reticulation is appeared in the alignment layer.

The alignment layer may be prepared by applying a coating liquid, containing the above polymer, and, if necessary, the crosslinkable agent, to a surface of a transparent substrate, drying under heating (crosslinking), and performing a rubbing treatment. The crosslinking reaction may be carried out at any time after applying the coating liquid. When a water-soluble polymer such as polyvinyl alcohol is used for preparation of an alignment layer, the coating liquid is desirably prepared using a mixed solvent of an organic solvent such as methanol, exhibiting a deforming function, and water. The weight ratio of water to methanol is desirably from 0/100 to 99/1, and more desirably from 0/100 to 91/9. Using such a mixed solvent can prevent bubbles from generating, and can remarkably reduce defects in the surface of the alignment layer and the retardation layer.

The coating liquid may be applied by any known method such as a spin-coating method, a dip coating method, a curtain coating method, extrusion coating method, rod coating method, or roll coating method. The rod coating method is especially preferred. The thickness of the alignment layer after being dried is desirably from 0.1 to 10 micrometers. Drying may be carried out at 20 to 110° C. In order to form sufficient crosslinking, drying is desirably carried out at 60 to 100° C., and more desirably at 80 to 100° C. The drying may be continued for 1 minute to 36 hours, and desirably for 1 minute to 30 minutes. The pH is desirably set in a proper range for a crosslinkable agent to be used, and when glutaraldehyde is used, the pH is desirably set within a range from 4.5 to 5.5, and more desirably 5.

The alignment layer may be formed on a transparent substrate. The alignment layer can be obtained by applying a rubbing treatment to the surface of the polymer layer after crosslinking the polymer layer.

The rubbing treatment may be carried out according to any known treatment used in a liquid-crystal alignment step of LCD. For example, the rubbing treatment may be carried out by rubbing the surface of a polymer layer with a paper, a gauze, a felt, a rubber, a nylon fiber, polyester fiber or the like in a direction. Usually, the rubbing treatment may be carried out by rubbing a polymer layer with a fabric in which fibers having a uniform length and line thickness are implanted averagely at several times.

In order to align discotic liquid-crystal molecules uniformly, vertical-alignment layers subjected to rubbing treatments are preferably used. On the other hand, in order to align rod-like liquid-crystal molecules uniformly, vertical-alignment layers without rubbing treatments are preferably used. It is noted that after a retardation layer is formed on an alignment layer, only the layer may be transferred from on the alignment layer to on another member such as a polarizing film, and in such case, the alignment layer is absent.

<<Agent for Vertical-Alignment at Air-Interface>>

Generally, liquid-crystal molecules tend to be aligned obliquely at an air-interface side, and, from viewpoint of uniformity of vertical-alignment, the molecules should also be controlled to be aligned vertically at an air-interface. For this purpose, a compound capable of contributing to aligning liquid-crystal molecules vertically may be added to a coating liquid to form a retardation layer. The compound may be localized in the air-interface side and give an effect such as a volume-excluding effect or an electrostatic effect on the liquid-crystal molecules so as to align them vertically. When the molecules are discotic molecules, the effect, which can align liquid-crystal molecules vertically, corresponds to an effect which can decrease a tilt angel of a director of the discotic molecules, or in other words, an effect which can decrease an angle between the director and a layer surface at an air-interface side. The compound is desirably selected from polymers, capable of giving a volume-excluding effect, comprising an inflexible unit such as a maleimide group.

The compounds described in JPA No. 2002-20363 and JPA No. 2002-129162 may be also used as a vertical-alignment agent at an air-interface. Those described in the columns [0072] to [0075] of Japanese Patent Application No. 2002-212100, in the columns [0037] to [0039] of Japanese Patent Application No. 2002-262239, in the columns [0071] to [0078] of Japanese Patent Application No. 2003-91752, in the columns [0052] to [0054], [0065] to [0066] and [0092] to [0094] of Japanese Patent Application No. 2003-119959, in the columns [0028] to [0030] of Japanese Patent Application No. 2003-330303 and in the columns [0087] to [0090] of Japanese Patent Application No. 2004-003804, are applied to the present invention. And such compounds can contribute to improvement in coating property and reduction of unevenness (“mura”) or cissing (“hajiki”) or the like.

The amount of the agent for vertical-alignment at an air-interface is desirably from 0.05 to 5 wt % in a coating liquid. When fluoride compounds are used as an agent for vertical-alignment at an air-interface, the amount of the agent is desirably not greater than 1 wt %.

<<Other Additives>>

Other additives such as plasticizers, surfactants or polymerizable monomers may be used with liquid-crystal compounds. Such additives may contribute to improvement in uniformity of a coating layer, strength of a coating layer, alignment ability of liquid-crystal molecules or the like. Such additives are desirably selected from materials which can be mixed with the liquid-crystal compound compatibly and don't inhibit the alignment of the liquid-crystal compound.

The polymerizable monomer may be selected from radical-polymerizable or cation-polymerizable compounds, and desirably selected from radical-polymerizable compounds having a plural function group, and among them, the compounds which can copolymerize with the polymerizable liquid crystal compound described above are preferred. Preferred examples of the polymerizable monomer include those described in the columns of [0018] to [0020] in JPA No. 2002-296423. In usual, the amount of the polymerizable monomer is desirably from 1 to 50 wt %, and more desirably from 5 to 30 wt %, with respect to the total weight of a single or plural liquid crystal compounds.

The surfactant may be selected from any known surfactants, and is desirably selected from fluoride-surfactants. More specifically, the compounds, described in the columns of [0028] to [0056] in JPA No. 2001-330725, and the compounds, described in the columns of [0069] to [0126] in JPA No. 2003-295212, are preferred.

Single or plural polymers may be used with the liquid crystal. The polymer is desirably selected from polymers which can increase a viscosity of a coating liquid. Examples of the polymer include cellulose esters. Preferred examples of cellulose ester include those described in the column [0178] in JPA No. 2000-155216. Avoiding inhibiting the alignment of the liquid-crystal compound, the amount of the polymer is desirably from 0.1 to 10 wt %, and more desirably from 0.1 to 8 wt %, with respect to the weight of the liquid-crystal compound.

The temperature at which the liquid-crystal compound transfers from a discotic nematic liquid-crystal state to a solid state is desirably from 70 to 300° C., and more desirably from 70 to 170° C.

[Substrate]

According to the present invention, a substrate supporting the retardation layer formed of a liquid-crystal composition may be used. The substrate is preferably transparent, and, in particular, preferably has a light transmission of not less than 80%. The substrate is preferably selected from polymer films having a small wavelength-dependence, and, in particular, preferably has a Re400/Re700 ratio of less than 1.2. The substrate is preferably selected from polymer films. According to the present invention, the substrate may function as a first retardation are, a second retardation area or a protective film of a polarizing film. The first or the second retardation area may be produced by laminating a retardation layer on a substrate supporting the layer such that the laminated body as a whole can satisfy the required optical properties for the first or the second retardation area.

The substrate is also preferably selected from polymer films with small optical anisotropy. The in-plane retardation, Re, of the substrate is preferably not greater than 20 nm, more preferably not greater than 10 nm and much more preferably not greater than 5 nm. For the embodiment in which the substrate also functions as a second retardation area, the retardation in thickness direction of the substrate is preferably from 50 to 200 nm, more preferably from 60 to 150 nm and much more preferably from 70 to 130 nm. For the embodiment in which the substrate also functions as a protective film of a polarizing film, the retardation in thickness direction of the substrate is preferably not greater than 25 nm, more preferably not greater than 20 nm and much more preferably not greater than 10 nm.

Examples of materials for the substrate, however not limited to them, include cellulose esters, polycarbonates, polysulfones, polyethersulfones, polyacrylates and polymethacrylates. Among these, cellulose esters are preferred, acetyl celluloses are more preferred and triacetyl celluloses are much more preferred. The thickness of the substrate is desirably from 20 to 500 micrometers, and more desirably from 40 to 200 micrometers.

In order to improve adhesion between the substrate and a layer formed thereon (for example, an adhesion layer, a vertical alignment layer or a retardation layer), the polymer film may be subjected to any surface treatment. Examples of surface treatments include corona discharge treatment, glow discharge treatment, flame treatment and UV irradiation treatment. An adhesion layer (an undercoating layer) may be formed on the substrate. A polymer layer containing inorganic particles having an average particle diameter of 10 to 100 nm in an amount of 5 wt % to 40 wt % with respect to the total weight of all solid ingredients is desirably formed on one side of the substrate, especially a long substrate, by coating or co-flow casting method, in order to improve a slide ability of the substrate in a feeding step or to prevent an adhesion of the surface to the rear surface of the substrate after being rolled up.

[Protective Film of a Polarizing Film]

The protective film of the second polarizing film is preferably transparent for a visible light range, and, in particular, preferably has a light transmission of not less than 80%. The protective film is preferably selected from polymer films with a small retardation caused by birefringence. In particular, the in-plane retardation, Re, of the protective film is preferably from 0 to 20 nm, more preferably from 0 to 10 nm and much more preferably from 0 to 5 nm. The retardation in thickness direction of the protective film is preferably from 0 to 40 nm, more preferably from 0 to 20 nm, and much more preferably from 0 to 10 nm. Any polymer films having such optical properties may be used as a protective film. From the viewpoint of durability of a polarizing film, cellulose acylate films or norbornene or norbornene derivatives films are preferred. The methods for lowering the Rth of the film are described in JPA No. hei 11-246704, JPA No. 2001-247717 or the specification of Japanese Patent Application No. 2003-379975. It is also possible to lower the Rth of a polymer film by thinning the thickness of the polymer film The thickness of the cellulose acylate film, which is used as a protective film of the second polarizing film, is preferably from 10 to 100 μm, more preferably from 10 to 60 μm and much more preferably from 20 to 45 μm.

### EXAMPLES

The present invention will further be detailed referring to specific Examples. It is to be noted that any materials, reagents, ratios of use thereof and operations shown in the Examples below can properly be modified without departing from the spirit of the present invention. Thus the present invention is by no means limited to the Examples described below.

### Example No. 1

<Preparation of an IPS-Mode Liquid-Crystal Cell No. 1>

Electrodes, shown in FIG. 1 as 2 and 3, were formed on a glass plate so that the distance between the electrodes was 20 μm, and a polyimide film was formed on the electrodes and subjected to rubbing treatment. The rubbing treatment was carried out in a direction shown in FIG. 1 as 4. A polyimide film was formed on another glass plate and subjected to rubbing treatment to form an alignment layer. Two such glass substrates were positioned with their alignment layers facing with their rubbing directions being parallel to each other and with a 3.9 micrometer gap between them. Nematic liquid-crystal composition, having a refractive-index anisotropy, Δn, of 0.0769 and a dielectric-constant anisotropy, Δε, of 4.5, was poured into the gap between the substrates to form a liquid-crystal layer. The d·Δn of the layer was 300 nm.

<Preparations of First Retardation Area No. 1 and Polarizing Plate No. 1>

A commercially available cellulose acylate film (“FUJITAC TD80UF” manufactured by FUJI PHOTO FILM CO., LTD.), of which Re is 3 nm and Rth is 45 nm, was saponified. A liquid, which was prepared by diluting a commercially available composition for a vertical-alignment layer (“JALS-204R” manufactured by JSR Corporation) with methyl ethyl ketone in a ratio of the composition to methyl ethyl ketone of 1, was applied to the saponified surface of the film with a wire-bar in an amount of 2.4 ml/m², and dried with a hot air of 120° C. for 120 seconds.

(Preparation of a Layer Formed of Rod-Like Molecules Aligned Vertically)

A coating solution was prepared by dissolving 3.8 g of a rod-like liquid-crystal compound shown below, 0.06 g of a polymerization initiator (IRGACURE 907 manufactured by Ciba-Geigy), 0.02 g of a sensitizer (KAYACURE-DETX manufactured by NIPPON KAYAKU CO., LTD.) and 0.002 g of a vertical alignment agent at an air-interface shown below in 9.2 g of methyl ethyl ketone, and the coating solution was applied to the surface of the alignment layer with a #3.5 wire-bar. After being attached to a metal frame, the coating layer was heated in a constant-temperature bath of 100° C. for 2 minutes to align the rod-like molecules.

After that, the layer was irradiated with UV light using a 120 w/cm high-pressurized mercury lamp at 100° C. for 30 seconds to crosslink the rod-like molecules, and cooled down the room temperature, and then a retardation layer formed of rod-like molecules was obtained. The obtained film, consisting of the substrate formed of the cellulose acylate film and the retardation layer formed of rod-like molecules, was used as Protective film No. 1.

Rod-like liquid-crystal compound

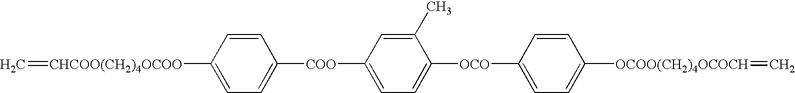

Vertical-alignment agent at an air-interface

Exemplified compound (II-4) described in the specification of Japanese Patent Application No. 2003-119959:

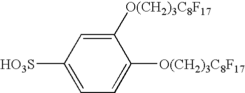

The optical property of the retardation layer, formed of rod-like molecules, was calculated in the manner as follows;

The dependence of Re on an incident angle of Protective film No. 1 was measured using an automatic birefringence analyzer (“KOBRA-21ADH” manufactured by Oji Scientific Instruments), and was subtracted an extent of contribution, which was measured previously, of the cellulose acylate film.

It was found that the Re and the Rth of the retardation layer were respectively 0 nm and −145 nm, and the rod-like molecules were substantially aligned vertically. It was also found that the retardation layer exhibited positive birefringence and its optical axis was substantially perpendicular to the layer surface. The retardation layer formed of rod-like molecules was used as First retardation area No. 1.

Iodine was adsorbed onto a stretched polyvinyl alcohol film to prepare a polarizing film. One side of the polarizing film was bonded with a polyvinyl alcohol-based adhesive to the cellulose acylate film surface of Protective film No. 1 in the manner such that the cellulose acetate film was disposed nearer to the polarizing film. A commercially available cellulose acylate film (“FUJITAC TD80UF” manufactured by FUJI PHOTO FILM CO., LTD.) was saponified and was bonded to the opposite surface of the polarizing film with polyvinyl alcohol-based adhesive. Thus, Polarizing plate No. 1 was obtained.

<Preparations of Second Retardation Area No. 1 and Polarizing Plate No. 2>

After the surface of a cellulose acetate film, produced in the same manner as the above, was saponified, a coating liquid having a formulation shown below was applied to the saponified surface using a wire bar coater in an amount of 20 ml/m², dried with hot air of 60° C. for 60 seconds and 100° C. for 120 seconds to form a polymer layer. The polymer layer was subjected to a rubbing treatment in a parallel direction to a slow axis of the film, and thus, an alignment layer was obtained.

Fomulation of Coating liquid for an alignment layer

| | | |
|---|---|---|
| Modified polyvinyl alcohol shown below | 10 | wt parts |
| Water | 371 | wt parts |
| Methanol | 119 | wt parts |
| Glutaraldehyde | 0.5 | wt parts |
| Tetramethyl ammonium fluoride | 0.3 | wt parts |
| Modified polyvinyl alcohol | | |
| 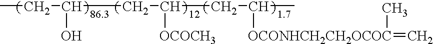 | | |

A coating solution was prepared by dissolving 1.8 g of a discotic liquid-crystal compound shown below, 0.2 g of Ethylene oxide-modified trimethyrol propane triacrylate (V#360 made by Osaka Organic Chemicals (Ltd.), 0.06 g of a polymerization initiator (IRGACURE 907 manufactured by Ciba-Geigy), 0.02 g of a sensitizer (KAYACURE-DETX manufactured by NIPPON KAYAKU CO., LTD.) and 0.01 g of a vertical-alignment agent at an air-interface, P-6 shown below, in 3.9 g of methyl ethyl ketone, and the coating solution was applied to the surface of the alignment layer with a #6 wire-bar. After being attached to a metal frame, the coating layer was heated in a constant-temperature bath of 125° C. for 3 minutes to align the discotic molecules. Subsequently, the layer was irradiated with UV light using a 120 w/cm high-pressurized mercury lamp at 100° C. for 30 seconds to crosslink the discotic molecules, and cooled down the room temperature, and then a retardation layer formed of discotic molecules was obtained. The obtained film, consisting of the substrate formed of the cellulose acylate film and the retardation layer formed of discotic molecules, was used as Protective film No. 2.

Discotic liquid-crystal compound

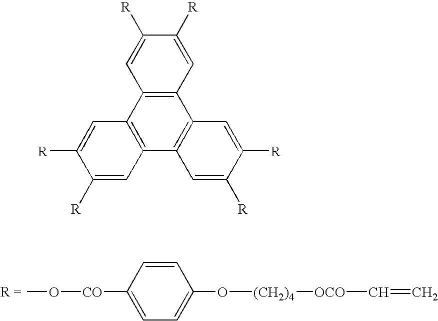

Vertical-alignment agent at an air-interface, P-6

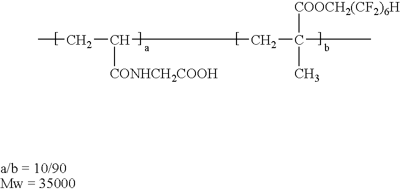

The optical property of the retardation layer, formed of discotic molecules, was calculated in the manner as follows;

The dependence of Re on an incident angle of Protective film No. 2 was measured using an automatic birefringence analyzer (“KOBRA-21ADH” manufactured by Oji Scientific Instruments), and was subtracted an extent of contribution, which was measured previously, of the cellulose acylate film.

It was found that the Re and the Rth of the retardation layer were respectively 215 nm and −117 nm, and the discotic molecules were substantially aligned vertically with a mean tilt angle of 89.9°. It was also found that the retention layer formed of discotic molecules exhibited negative birefringence, its optical axis was substantially parallel to the layer surface and its slow axis was parallel to the rubbing direction of the alignment layer. The retardation layer formed of discotic molecules was used as Second retardation area No. 1.

Iodine was adsorbed onto a stretched polyvinyl alcohol film to prepare a polarizing film One side of the polarizing film was bonded with a polyvinyl alcohol-based adhesive to the cellulose acylate film surface of Protective film No. 2 in the manner such that the cellulose acetate film was disposed nearer to the polarizing film. The transmission axis of the polarizing film was positioned orthogonal to the slow axis of Protective film No. 2 (equal to the slow axis of Second retardation area No. 1). A commercially available cellulose acylate film (“FUJITAC TD80UF” manufactured by FUJI PHOTO FILM CO., LTD.) was saponified and was bonded to the opposite surface of the polarizing film with polyvinyl alcohol-based adhesive. Thus, Polarizing plate No. 2 was obtained. The obtained polarizing plate was bonded to one side of an EPS liquid-crystal cell No. 1 prepared as set forth above so that the retardation layer, formed of discotic molecules, was disposed at the side of the liquid-crystal cell. The slow axis of Protective film No. 2 was made orthogonal to the rubbing direction of the alignment layer of the liquid-crystal cell, or in other words, the slow axis of Second retardation area No. 1 was orthogonal to the slow axis of the liquid-crystal cell in a black state. Polarizing plate No. 1 prepared as set forth above was bonded to another side of the cell in a cross-nicole alignment. Thus, a liquid-crystal display was produced.

<Measurement of Light Leakage from the LCD>

Light leakage from the LCD was measured. Observed from a distance in a leftward 60° oblique direction, it was found that light leakage was 0.04%.

### Example No. 2

<Preparation of Second Retardation Area No. 2>

After the surface of commercially available cellulose acetate film was saponified, a coating liquid having a formulation shown below was applied to the saponified surface using a wire bar coater in an amount of 20 ml/m², dried with hot air of 60° C. for 60 seconds and 100° C. for 120 seconds to form a polymer layer. The polymer layer was subjected to rubbing treatment in a parallel direction to a slow axis of the film, and thus, an alignment layer was obtained.

Formulation of Coating liquid for an alignment layer

| | |
|---|---|
| Modified polyvinyl alcohol shown above | 10 wt parts |
| Water | 371 wt parts |
| Methanol | 119 wt parts |
| Glutaraldehyde | 0.5 wt parts |
| p-toluene sulfonic acid | 0.3 wt parts |

A coating solution was prepared by dissolving 1.8 g of a discotic liquid-crystal compound shown above, 0.2 g of Ethylene oxide-modified trimethyrol propane triacrylate (V#360 made by Osaka Organic Chemicals (Ltd.), 0.06 g of a polymerization initiator (IRGACURE 907 manufactured by Ciba-Geigy), 0.02 g of a sensitizer (KAYACURE-DETX manufactured by NIPPON KAYAKU CO., LTD.) and 0.01 g of a vertical alignment agent at an air-interface, P-6 shown above, in 3.9 g of methyl ethyl ketone, and the coating solution was applied to the surface of the alignment layer with a #5.4 wire-bar. After being attached to a metal frame, the coating layer was heated in a constant-temperature bath of 125° C. for 3 minutes to align the discotic molecules. Subsequently, the layer was irradiated with UV light using a 120 w/cm high-pressurized mercury lamp at 100° C. for 30 seconds to crosslink the discotic molecules, and cooled down the room temperature, and then a retardation layer formed of discotic molecules was obtained.

The optical property of the retardation layer, formed of discotic molecules, was calculated in the manner as follows;

The dependence of Re on an incident angle of the laminated body of the cellulose acylate film and the retardation layer was measured using an automatic birefringence analyzer (“KOBRA-21ADH” manufactured by Oji Scientific Instruments), and was subtracted an extent of contribution, which was measured previously, of the cellulose acylate film.

It was found that the Re and the Rth of the retardation layer were respectively 195 nm and −98 nm, and the discotic molecules were substantially aligned vertically with a mean tilt angle of 89.9°. It was also found that the retardation layer formed of discotic molecules exhibited negative birefringence, its optical axis was substantially parallel to the layer surface and its slow axis was parallel to the rubbing direction of the alignment layer The retardation layer formed of discotic molecules was used as Second retardation area No. 2.

Next, Protective film No. 3 was produced in the same manner as Protective film No. 1, except that a retardation layer, having Rth of −160 nm, was formed of rod-like molecules. The retardation layer was positive birefringent and its optical axis was substantially perpendicular to the layer surface. And Polarizing plate No. 3 was produced in the same manner as Polarizing plate No. 1, except that Protective film No. 3 was used in the place of Protective film No. 1. An adhesion was applied to the surface of the retardation layer, formed of rod-like molecules, of Polarizing plate No. 3, and the retardation layer formed of discotic molecules, or in other words Second retardation area No. 2, was bonded to the surface with the adhesion such that the slow axis of the Second retardation No. 2 was parallel to the transmission axis of Polarizing plate No. 3. After pressured with a roller, the cellulose acylate, which was the substrate for the retardation layer formed of discotic molecules, was peeled off so that the retardation layer formed of discotic molecules was transferred to Polarizing plate No. 3. Thus, Polarizing Plate No. 4 was obtained.

Polarizing plate No. 4 was bonded to one side of an IPS liquid-crystal cell No. 1 prepared as set forth above so that the retardation layer formed of discotic molecules was disposed at the side of the liquid-crystal cell. The slow axis of Second retardation area No. 2 was made orthogonal to the rubbing direction of the alignment layer of the liquid-crystal cell, or in other words, the slow axis of Second retardation area No. 2 was orthogonal to the slow axis of the liquid-crystal cell in a black state. A commercially available polarizing plate (“HLC2-5618” manufactured by SANRITZ CORPORATION) was bonded to another side of the cell in a cross-nicole alignment. Thus, a liquid-crystal display was produced.

<Measurement of Light Leakage from the LCD>

Light leakage from the LCD was measured. Observed from a distance in a leftward 60° oblique direction, it was found that light leakage was 0.03%.

### Example No. 3

(Preparation of Substrate No. 1)

The following components were put in a mixing tank and stirred with heating to prepare a cellulose acetate solution A.

<Formulation of Cellulose Acetate Solution A>

| | |
|---|---|
| Cellulose acetate with 2.86 substitution degree | 100 weight parts |
| Triphenyl phosphate(plasticizer) | 7.8 weight parts |
| Biphenyldiphenyl phosphate(plasticizer) | 3.9 weight parts |
| Methylene chloride(first solvent) | 300 weight parts |
| Methanol(second solvent) | 54 weight parts |
| 1-Butanol(third solvent) | 11 weight parts |

The following components were put in another mixing tank and stirred with heating to prepare an additive solution B-1.

<Formulation of Additive Solution B-1>

| | | |
|---|---|---|
| Methylene chloride | 80 | weight parts |
| Methanol | 20 | weight parts |
| Agent for lowering | 40 | weight parts |
| optical anisotropy shown below | | |

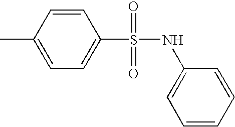

Mixing 477 weight parts of the cellulose acetate solution A and 40 weight parts of the additive solution B-1 under stirring sufficiently, and, thus, a dope was prepared. The obtained dope was made to flow from an opening onto a drum cooled at 0° C. The film, having a residual solvent content of 70 weight %, was peeled off and dried while the both width-ends of the film being fixed with a pin tenter, which was same as described in FIG. 3 of JPA No. hei 4-1009, such as the residual solvent content was kept from 3 to 5 wt % and the width of the film was kept in a laterally (in a direction normal to the machine direction) stretching ratio of 3%. After that, the film was dried while being fed between two rolls of a thermal treatment equipment, to thereby form Substrate No. 1 having a thickness of 80 μm.

The optical property of the film was obtained by measuring a dependence of Re on an incident angle using an automatic birefringence analyzer (“KOBRA-21ADH” manufactured by Oji Scientific Instruments), and it was found that Substrate No. 1 had Re of 1 nm and Rth of 6 nm.

<Productions of Second Retardation Area No. 3 and Polarizing Plate No. 5>

A retardation layer formed of discotic molecules was formed on Substrate No. 1 in the same manner as Example No. 1, except that Substrate No. 1 was used and the discotic liquid-crystal coating solution was applied with a #4.8 bar, and, thus, Protective film No. 4 was produced. The optical property of the retardation layer formed of discotic molecules was obtained by measuring a dependence of Re on an incident angle using an automatic birefringence analyzer (“KOBRA-21ADH” manufactured by Oji Scientific Instruments), and it was found that the retardation layer formed of discotic molecules had Re of 172 nm and Rth of −86 nm, that discotic molecules were aligned vertically to the film surface, and that the slow axis was parallel to the rubbing direction of the alignment layer. The retardation layer with negative birefringence, of which optical axis was substantially parallel to the layer surface, was obtained. The obtained layer was used as Second retardation area No. 3.

Iodine was adsorbed onto a stretched polyvinyl alcohol film to prepare a polarizing film One side of the polarizing film was bonded with a polyvinyl alcohol-based adhesive to Substrate No. 1 surface of Protective film No. 4 in the manner such that Substrate No. 1 was disposed nearer to the polarizing film. The polarizing film and Protective film No. 4 were disposed such that the transmission axis of the polarizing film was orthogonal to the slow axis of Protective film No. 4, or in other words the slow axis of Second retardation area No. 3. A commercially available cellulose acylate film (“FUJITAC TD80UF” manufactured by FUJI PHOTO FILM CO., LTD.) was saponified and was bonded to the opposite surface of the polarizing film with polyvinyl alcohol-based adhesive. Thus, Polarizing plate No. 5 was obtained.

Polarizing plate No. 5 was bonded to one side of an EPS liquid-crystal cell No. 1 prepared as set forth above so that the retardation layer formed of discotic molecules, Second retardation area No. 3, was disposed at the side of the liquid-crystal cell. The slow axis of Second retardation area No. 3 was made orthogonal to the rubbing direction of the alignment layer of the liquid-crystal cell, or in other words, the slow axis of Second retardation area No. 3 was orthogonal to the slow axis of the liquid-crystal cell in a black state. Polarizing plate No. 1, which was produced in the same manner as Example No. 1, was bonded to another side of the cell in a cross-nicole alignment so that the retardation layer formed of rod-like molecules was disposed at the side of the cell. Thus, a liquid-crystal display was produced. Light leakage from the LCD was measured. Observed from a distance in a leftward 60° oblique direction, it was found that light leakage was 0.02%.

### Example No. 4

<Productions of Second Retardation Area No. 4 and Polarizing Plate No. 6>

A solution was prepared by dissolving 170 g of styrene based polymer, which was prepared by graft polymerization of 10 wt parts of Copolymer (A) described below with 90 wt parts of Monomer mixture (B) having a formulation described below, in 830 g of dichloromethane.
(A) styrene/butadiene copolymer (weight ratio: 20/80)
(B) styrene/acrylonitrile/α-methylstyrene (weight ratio: 60/20/20)

The solution was casting on a glass plate such that a film having a thickness of 100 μm was obtained after being dried. Left for 5 minutes at room temperature, the film was dried with hot air at 45° C. for 20 minutes, and, then, peeled off from the glass plate. The film was attached to a rectangular flame, and dried at 70° C. for 1 hr. After dried at 110° C. for 15 hours, the film was stretched uniaxially with a 1.9 times ratio at 115° C. using a tensile testing machine (“Strograph R2” manufactured by Toyo Seiki Seisaku-sho, LTD.). And, thus, a uniaxially-stretched styrene-based polymer film, Second retardation area No. 4, was obtained. The retardation values of the film were measured and it was found that the Re value was 175 nm and the Rth value was −88 nm. The film with a positive birefringence, of which optical axis was parallel to the film surface (or in other words was in-plane), was obtained. The film was used as Second retardation area No. 4.

Iodine was adsorbed onto a stretched polyvinyl alcohol film to prepare a polarizing film. One side of the polarizing film was bonded with a polyvinyl alcohol-based adhesive to Substrate No. 1, which was produced in the same manner as Example No. 3. And Second retardation area No. 4 was bonded to the surface of Substrate No. 1 with a commercially available adhesive such that the slow axis of Second retardation area No. 4 was orthogonal to the transmission axis of the polarizing film. A commercially available cellulose acylate film (“FUJITAC TD80UF” manufactured by FUJI PHOTO FILM CO., LTD.) was saponified and was bonded to the opposite surface of the polarizing film with polyvinyl alcohol-based adhesive. Thus, Polarizing plate No. 6 was obtained.

Polarizing plate No. 6 was bonded to one side of an EPS liquid-crystal cell No. 1 prepared as set forth above so that the surface of the polystyrene-based polymer film of Second retardation area No. 4 was disposed at the side of the liquid-crystal cell. The slow axis of Second retardation area No. 4 was made orthogonal to the rubbing direction of the alignment layer of the liquid-crystal cell, or in other words, the slow axis of Second retardation area No. 4 was orthogonal to the slow axis of the liquid-crystal cell in a black state. Polarizing plate No. 1, which was produced in the same manner as Example No. 1, was bonded to another side of the cell in a cross-nicole alignment. Thus, a liquid-crystal display was produced.

<Measurement of Light Leakage from the LCD>

Light leakage from the LCD was measured. Observed from a distance in a leftward 60° oblique direction, it was found that light leakage was 0.02%.

### Example No. 5

<Production of Ferroelectric Liquid-Crystal Cell No. 1>

A polyimide film was formed on an electrode having an ITO electrode thereon, and was subjected to a rubbing treatment to form an alignment layer. Another electrode having an ITO was treated in the same manner. Two substrates were positioned with their alignment layers facing, with their rubbing directions being parallel to each other and with a 3.9 micrometer gap between them. Ferroelectric liquid-crystal composition, having a refractive-index anisotropy, Δn, of 0.15 and an intrinsic polarization, Ps, of 12 nCcm⁻², was poured into the gap between the substrates to form a liquid-crystal layer. The d·Δn of the layer was 280 nm. Polarizing plate No. 4, which was produced in the same manner as Example No. 2, was bonded to the one side of Ferroelectric liquid-crystal cell No. 1 such that the retardation layer formed of discotic molecules of Polarizing plate No. 4 was disposed at the side of the cell. The slow axis of Second retardation area No. 2 of Polarizing plate No. 4 was made orthogonal to the slow axis of liquid-crystal molecules in the cell while being applied 10 V direct-current voltage. A commercially available polarizing plate (“HLC2-5618” manufactured by SANRITZ CORPORATION) was bonded to another side of the cell in a cross-nicole alignment Thus, a liquid-crystal display was produced.

Light leakage from the LCD was measured. Observed from a distance in a leftward 60° oblique direction, it was found that light leakage was 0.4%.

### Comparative Example No. 1

Two commercially available polarizing plates (“HLC2-5618” manufactured by SANRITZ CORPORATION) were bonded both sides of IPS mode Liquid crystal cell No. 1, prepared in the same manner as the above, so that two were positioned in a cross-nicole alignment. Thus, a liquid-crystal display was produced. No optical compensatory film was used. As in the manner of Example No. 1, the upside polarizing plate was bonded so that the transmission axis was parallel to the rubbing direction of the cell.

Light leakage was measured in the same manner of Example No. 1. Observed from a distance in a leftward 60° oblique direction, it was found that light leakage was 0.55%.

### Comparative Example No. 2

Polarizing plate No. 2, which was produced in the same manner as the above, was bonded to the one side of liquid-crystal cell No. 1, which was produced in the same manner as the above, such that the retardation layer formed of discotic molecules of Polarizing plate No. 2 was disposed at the side of the cell. The slow axis of Protective film No. 2 was made parallel to the rubbing direction of the cell, or in other words the slow axis of Second retardation area No. 1 was parallel to the slow axis of the liquid-crystal cell in the black state. A commercially available polarizing plate (“HLC2-5618” manufactured by SANRITZ CORPORATION) was bonded to another side of the cell in a cross-nicole alignment. Thus, a liquid-crystal display was produced.

Light leakage was measured in the same manner of Example No. 1. Observed from a distance in a leftward 60° oblique direction, it was found that light leakage was 1.5%.

### Comparative Example No. 3

Polarizing plate No. 4, which was produced in the same manner as Example No. 2, was bonded to the one side of liquid-crystal cell No. 1, produced in the same manner as Example No. 1, such that the retardation layer formed of discotic molecules of Polarizing plate No. 4 was disposed at the side of the cell. The slow axis of Second retardation area No. 2 was made parallel to the rubbing direction of the cell, or in other words the slow axis of Second retardation area No. 2 was parallel to the slow axis of the liquid-crystal cell in a black state. A commercially available polarizing plate (“HLC2-5618” manufactured by SANRITZ CORPORATION) was bonded to another side of the cell in a cross-nicole alignment. Thus, a liquid-crystal display was produced.

Light leakage was measured in the same manner of Example No. 1. Observed from a distance in a leftward 60° oblique direction, it was found that light leakage was 5.2%.

Having described our invention as related to the present embodiments, it is our intention that the invention not be limited by any of the details of the description, unless otherwise specified, but rather be construed broadly within its spirit and scope as set out in the accompanying claims.

1. A liquid-crystal display comprising at least;
a first polarizing film,
a first retardation area, with a positive birefringence, of which an optical axis is perpendicular to a plane;
a second retardation area, with a negative birefringence, of which an optical axis is parallel to a plane; and
a liquid-crystal cell comprising a pair of substrates and a liquid-crystal layer sandwiched in between the pair of substrates, in which liquid-crystal molecules are parallel to surfaces of the pair of substrates in a black state;
wherein a retardation in thickness-direction, Rth, of the first retardation area falls within the range from −40 to −250 nm, an in-plane retardation, Re, of the second retardation area falls within the range from 50 to 400 nm, and a slow axis of the second retardation area is substantially orthogonal to a slow axis of the liquid-crystal layer in a black state.

2. The liquid-crystal display of claim 1, wherein the first polarizing film, the first retardation area, the second retardation area and the liquid-crystal cell are disposed in this order, and the slow axis of the second retardation area is substantially parallel to a transmission axis of the first polarizing film.

3. The liquid-crystal display of claim 1, wherein the first retardation area, the liquid-crystal cell, the second retardation area and the first polarizing film are disposed in this order, and the slow axis of the second retardation area is substantially orthogonal to a transmission axis of the first polarizing film.

4. The liquid-crystal display of claim 1 further comprising a second polarizing film of which a transmission axis is orthogonal to the transmission axis of the first polarizing film, wherein the fist retardation area, the second retardation area and the liquid-crystal cell are disposed between the first and the second polarizing films.

5. The liquid-crystal display of claim 1, wherein the first retardation area comprises a retardation layer comprising rod-like liquid-crystal molecules aligned vertically.

6. The liquid-crystal display of claim 1, wherein the first retardation area comprises a retardation layer comprising discotic liquid-crystal molecules aligned vertically.

7. The liquid-crystal display of claim 1 further comprising a pair of protective films sandwiching the first polarizing film, wherein a retardation in thickness-direction, Rth, of the protective film, being disposed nearer to the liquid-crystal cell than another, is not greater than 25 nm.

8. The liquid-crystal display of claim 1 further comprising a pair of protective films sandwiching the first polarizing film, wherein the protective film, being disposed nearer to the liquid-crystal cell than another, is a cellulose acylate film or a norbornene film.

9. The liquid-crystal display of claim 4 further comprising a pair of protective films sandwiching the second polarizing film, wherein a retardation in thickness-direction, Rth, of the protective fin, being disposed nearer to the liquid-crystal cell than another, is not greater than 25 nm.

10. The liquid-crystal display of claim 4 further comprising a pair of protective films sandwiching the second polarizing film, wherein the protective film, being disposed nearer to the liquid-crystal cell than another, is a cellulose acylate film or a norbornene film.
